(19) United States
(12) Patent Application Publication
(10) Pub. No.: US 2006/0194010 A1
(43) Pub. Date: Aug. 31, 2006

(54) Packaging structure including a degradable tie layer

(76) Inventor: Don Hiscock, St. Louis, MO (US)

Correspondence Address: SOLAE, LLC, PO BOX 88940, ST LOUIS, MO, 63188, US

(21) Appl. No.: 11/068,624

(22) Filed: Feb. 28, 2005

(51) Int. Cl. B32B 27/08

(52) U.S. Cl. 428/35.7

(57) ABSTRACT

This invention relates to a packaging structure having degradable properties; comprising, (A) a substrate layer; (B) a resin layer; and (C) a degradable tie layer; wherein the degradable tie layer resides between the substrate layer and the resin layer. Further, the invention relates to a process for making a packaging structure having degradable properties; comprising, applying between (A) a substrate layer; and (B) a resin layer; (C) a degradable tie layer.

### FIELD OF THE INVENTION

This invention relates to a process for forming a packaging structure with a degradable tie layer and a packaging structure composition including a degradable tie layer. The degradable tie layer comprises a vegetable protein material, in particular, a soy protein material. A tie layer refers to a strongly adhering interlayer in a multilayer structure that serves to bind two, often dissimilar materials.

### BACKGROUND OF THE INVENTION

Liquid product and food packaging often use cellulose-based paperboard which has been extrusion-coated with barrier resins such as low density polyethylene (LDPE) or polyethylene terephthalate (PET). Although producers of these resins have considered improved degradability in the design of some products, the industry has not succeeded in making materials that are highly degradable due in part to the high resin film weights needed for adhesion or packaging performance. This makes degradation of the structure more difficult, since most biological or environmental mechanisms for resin degradation are promoted by high surface area, and resins bonded to cellulose fiber substrates are less susceptible to degradation. The regulatory and social environment at both the national and state level is creating a need for packaging structures that are more degradable. There is a need for packaging structures that degrade in the environment, and strong bonds between resin and cellulosic fibers do not lead to degradation.

In addition to degradation, the recycling of packaging materials is adversely affected by resin/cellulosic substrates in the waste stream. Recyclers of secondary papermaking fibers will often not accept extrusion-coated or extrusion-laminated paperboard because the resin remains tightly bound to the cellulosic fibers and these thermoplastic contaminants lead to defects and lost production during papermaking with recycled fibers. There is a need for resin coatings that can be easily separated from the cellulosic substrate during recycling, yet still have satisfactory properties as the packaging material is used.

Adhesion of the resin film to the cellulose fibers or similar substrate is driven by a number of factors, which although complicated in detail, have been summarized generally in a number of references. The Handbook of Adhesive Bonding, edited by Charles Cagle, McGraw-Hill, 1973, discusses the main fundamental forces involved in adhesive bonding as (1) physical adsorption due to van der Waals or secondary forces, (2) hydrogen bonding, in molecules containing hydroxyl (OH) groups, and (3) chemisorption, in which functional groups on a molecule, often in the terminal position, bond chemically with a substrate. Other factors contributing to adhesion include roughness, diffusion, cleanliness, heat, pressure and mechanical energy. In all cases, surface energy and wetting phenomena are important to ensure the fluid or molten material contacting the substrate wets and spreads on the solid surface. Normally, the internal cohesive strength of a tie layer must be greater than the adhesive strength to the other laminate plies, or the tie layer will fail under stress before either of the bonded substrate layers.

For these reasons, we can expect that a material that provides a combination of properties promoting adhesion to surfaces with good cohesive strength, yet subject to degradation and loss of cohesive strength would produce a unique combination of strong adhesion in most cases, but allow separation or recycling of the structure under certain conditions.

Protein materials are well known as adhesives and as binders for use in pigment containing coatings. Protein materials commonly used as adhesives or binders include casein, soybean protein materials including soy protein isolate, soy protein concentrate, soy flour and soy meal. Soy protein isolates can be modified chemically or enzymatically to enhance the effectiveness of the protein material as an adhesive and a degradable tie layer. Soy protein polymers promote adhesion to the substrate through the amphiphilic and amphoteric functionality of the amino acids comprising the protein. The inherent cohesion of the polymers, such as soy protein, allows them to function as a strong adhesive. Soy protein coating is not being used for its adhesive or degradable properties on most extrusion coated or laminated packaging structures. In those cases, adhesion is promoted through the use of an electrical discharge corona system or through the use of highly cationic primers such as polyethylene imine to raise the surface energy of the substrate, thereby promoting better wetting by the resin and higher electrostatic interactions binding the materials. These methods of adhesion do not have biodegradable properties. None of the current technologies incorporate the use of a degradable polymer that maintains and promotes adhesion of the polymer to the substrate and then later degrades.

It is therefore an object of the invention to provide a process for forming a packaging structure that includes an adhesive degradable tie layer between a substrate layer and a resin layer.

It is another object of the invention to provide a packaging structure composition containing a degradable tie layer which will be adhesive to both the substrate layer and resin layer and further the degradation of the packaging structure in the environment or by a recycling process.

### SUMMARY OF THE INVENTION

A process for forming a packaging structure with enhanced degradable properties is provided. A packaging structure composition having degradable properties is also provided.

The invention is directed to a packaging structure having degradable properties; comprising,
a substrate layer;
a resin layer; and
a degradable tie layer;
   wherein the degradable tie layer resides between the substrate layer and the resin layer.

The invention is also directed to a process for making a packaging structure having degradable properties; comprising,

applying between

a substrate layer; and
a resin layer;
a degradable tie layer.

The packaging structure includes (A) a substrate layer, (B) a resin layer and a (C) degradable tie layer. The degradable tie layer (C) is applied to the substrate layer (A) surface prior to extrusion coating or lamination, as a pretreatment or during the fabrication of the substrate.

A protein material is provided for use as the degradable tie layer material. The protein material is preferably a soy protein polymer.

Alternate materials that could be used for the packaging composition degradable tie layer are those materials having a combination of degradable and adhesive properties. These include materials drawn from the natural polymer classes of vegetable and animal proteins, cellulosic ethers, starches, vegetable gums, amphoteric latexes, resins, synthetic polymers and combinations thereof.

The degradable tie layer (C) between a substrate layer (A) and a resin layer (B) promotes improvement in resin adhesion to the substrate layer (A) and accelerates degradation of the substrate-resin interface through degradation of the degradable tie layer (C) in the environment or through recycling operations.

A soy protein polymer, when used as the degradable tie layer (C), promotes adhesion to the substrate layer (A) surface through amphiphilic and amphoteric functionality of the amino acids comprising the protein. The term “amphiphilic” functionality means that the molecule has a polar, water-soluble group attached to a nonpolar, water-insoluble hydrocarbon. The term “amphoteric” functionality means that the molecule has the characteristics of an acid and a base and is capable of reacting chemically either as an acid or a base.

The soy protein polymer will rapidly degrade in most environments through the bacterial or fungal enzymatic degradation of the protein. Alternatively, the bond between the extruded resin layer (B) and the soy protein polymer layer (C) can preferentially be broken in recycling through re-solubilization of the polymer by using, for example, an elevated temperature and adding an alkali such as sodium hydroxide.

### DETAILED DESCRIPTION OF THE INVENTION

The present invention is directed to the creation of a packaging structure containing a degradable tie layer (C). The degradable tie layer (C) promotes both adhesion between the substrate layer (A) and the resin layer (B) and degradation of the bond at the substrate-resin interface.

The Substrate Layer (A)

The substrate layer (A) may be composed of a variety of materials. These may include a coated or uncoated cellulose based paper or coated or uncoated paperboard made from cellulose fibers derived from wood and non-wood sources, woven or non-woven webs made from synthetic fibers, as well as other materials. The substrate may be a solid bleached or non-bleached sulfate paperboard. Vendors who supply paperboard are International Paper (Memphis, Tenn.), Georgia-Pacific (Atlanta, Ga.) and MeadWestvaco (Stamford, Conn.).

In a further embodiment, a pigment layer is applied to the substrate layer (A). The purpose of the pigment layer is to improve the surface smoothness, gloss, and print quality of the substrate layer (A). When the pigment layer is employed, the degradable tie layer (C) is applied over the pigment layer or formulated into the pigment layer. That is, the pigment layer may reside between the substrate layer (A) and the degradable tie layer (C). Alternatively, the degradable tie layer (C) may be combined with the pigmented layer such that the layer contains pigments to improve the surface appearance as well as a degradable material which provides strong adhesion. Paper coating pigments suitable for use in the paper coating formulations of the present invention are well known to those skilled in the art and disclosed, for example, in U.S. Pat. No. 6,030,443, issued to Bock, et al. (Feb. 29, 2000) and U.S. Pat. No. 5,766,331, issued to Krinski, et al. (Jun. 16, 1998), both of which are incorporated in their entirety by reference.

As noted above, the pigment or pigments in the paper coating formulation fills in irregularities in the paper surface. This results in an even and uniformly absorbent surface for printing and improves the overall appearance of the coated sheet. The choice of pigments to be used in the paper coating formulations described herein is based on the resulting properties desired in the paper surface. Suitable exemplary pigments for use in the paper coating formulation of the present invention include calcium carbonate (synthetic, precipitated material, or ground from naturally occurring mineral), calcined kaolin clay, hydrous kaolin clay, China clay, talc, mica, dolomite, silica, silicates, zeolite, gypsum, satin white, titanium dioxide, titanium dioxide, calcium sulfate, barium sulfate, aluminum trihydrate, lithopone, blanc fixe, plastic pigment, and combinations thereof.

Substrate weights for extrusion coated or extrusion laminated resin applications include lightweight flexible films and papers and rigid paperboards. The weight of the substrate layer (A) ranges from about 15 g/m² to about 600 g/m².

The Resin Layer (B)

Different commercial applications may call for a variety of resin layers. Accordingly, in one preferred embodiment the resin layer (B) is comprised of an extruded resin. In another preferred embodiment, the resin layer (B) is comprised of a film laminate layer. A wide variety of materials may be used as the extruded resin or film laminate layer. Among these are any of the following exemplary materials: high density polyethylene (HDPE), low density polyethylene (LDPE), linear low density polyethylene (LLDPE), orientated polypropylene (OPP). Some additional thermoplastic materials are PTFE, FEP, PVDF, and PET, that may be readily incorporated into the claimed invention.

The amount of the resin layer (B) that resides on the degradable tie layer (C) is from about 10 to about 60 grams per square meter (g/m²) or at a film thickness ranging from about 12 μm to about 50 μm; preferably from about 15 to about 55 g/m² and most preferably from about 20 to about 50 g/m².

The Degradable Tie Layer (C)

The degradable tie layer (C) is a material is selected from the group consisting of polymers of vegetable and animal proteins, cellulosic ethers, starches, vegetable gums, amphoteric latexes, resins, synthetic polymers and combinations thereof.

The protein polymer material within (C) may be a polymer of any vegetable or animal protein. Preferred protein polymer materials useful in the composition of the present invention include soy protein polymer materials, casein or caseinates, corn protein polymer materials—particularly zein, and wheat gluten. Preferred protein polymers also include dairy whey protein polymers, and non-dairy-whey protein polymers such as bovine serum albumin, egg white albumin, and vegetable whey protein polymers (i.e., non-dairy whey protein polymer) such as from soy protein polymer.

Soybean protein polymer materials which are useful with the present invention are soy concentrate and most preferably soy protein isolate. The soy concentrate, and soy protein isolate are formed from a soybean starting material which may be soybeans or a soybean derivative. Preferably the soybean starting material is either soybean cake, soybean chips, soybean meal, soybean flakes, or a mixture of these materials. The soybean cake, chips, meal, or flakes may be formed from soybeans according to conventional procedures in the art, where soybean cake and soybean chips are formed by extraction of part of the oil in soybeans by pressure or solvents, soybean flakes are formed by cracking, heating, and flaking soybeans and reducing the oil content of the soybeans by solvent extraction, and soybean meal is formed by grinding soybean cake, chips, or flakes.

The soy concentrate and soy protein isolate are described below as containing a protein range based upon a “moisture free basis” (mfb).

Soy concentrate, as the term is used herein, refers to a soy protein polymer material containing about 65% to about 72% of soy protein (mfb). Soy concentrate is preferably formed from a commercially available defatted soy flake material from which the oil has been removed by solvent extraction. The soy concentrate is produced by an acid leaching process or by an alcohol leaching process. In the acid leaching process, the soy flake material is washed with an aqueous solvent having a pH at about the isoelectric point of soy protein, preferably at a pH of about 4.0 to about 5.0, and most preferably at a pH of about 4.4 to about 4.6. The isoelectric wash removes a large amount of water soluble carbohydrates and other water soluble components from the flakes, but removes little of the protein and fiber, thereby forming a soy concentrate. The soy concentrate is dried after the isoelectric wash. In the alcohol leaching process, the soy flake material is washed with an aqueous ethyl alcohol solution wherein ethyl alcohol is present at about 60% by weight. The protein and fiber remain insoluble while the carbohydrate soy sugars of sucrose, stachyose and raffinose are leached from the defatted flakes. The soy soluble sugars in the aqueous alcohol are separated from the insoluble protein and fiber. The insoluble protein and fiber in the aqueous alcohol phase are then dried.

Soy protein isolate, as the term is used herein, refers to a soy protein polymer containing at least about 90% or greater protein content, and preferably from about 92% or greater protein content on a moisture free basis, before modifications such as carboxylation, alkaline hydrolysis and drying as neutralized sodium- or ammonium-salt forms. These modifications reduce or dilute the nitrogen content of the polymer, and often result in an industrial soy protein isolate polymer with a protein content lower than 90% on a moisture free basis when measured as the percent nitrogen times 6.25. These modified products, however, are still the soy protein polymers of the present invention, and have a function in paper coatings.

Soy protein isolate is typically produced from a starting material, such as defatted soybean material, in which the oil is extracted to leave soybean meal or flakes. More specifically, the soybeans may be initially crushed or ground and then passed through a conventional oil expeller. It is preferable, however, to remove the oil contained in the soybeans by solvent extraction with aliphatic hydrocarbons, such as hexane or azeotropes thereof, and these represent conventional techniques employed for the removal of oil. The defatted soy protein material or soybean flakes are then placed in an aqueous bath to provide a mixture having a pH of at least about 6.5 and preferably between about 7.0 and 10.0 in order to extract the protein. Typically, if it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the protein. Typically, the pH of the aqueous extract of protein will be at least about 6.5 and preferably about 7.0 to 10.0. The ratio by weight of the aqueous extractant to the vegetable protein material is usually between about 20 to 1 and preferably a ratio of about 10 to 1. In an alternative embodiment, the vegetable protein is extracted from the milled, defatted flakes with water, that is, without a pH adjustment.

It is also desirable in obtaining the soy protein isolate used in the present invention, that an elevated temperature be employed during the aqueous extraction step, either with or without a pH adjustment, to facilitate solubilization of the protein, although ambient temperatures are equally satisfactory if desired. The extraction temperatures which may be employed can range from ambient up to about 120° F. with a preferred temperature of 90° F. The period of extraction is further non-limiting and a period of time between about 5 to 120 minutes may be conveniently employed with a preferred time of about 30 minutes. Following extraction of the vegetable protein material, the aqueous extract of protein can be stored in a holding tank or suitable container while a second extraction is performed on the insoluble solids from the first aqueous extraction step. This improves the efficiency and yield of the extraction process by exhaustively extracting the protein from the residual solids from the first step.

The combined, aqueous protein extracts from both extraction steps, without the pH adjustment or having a pH of at least 6.5, or preferably about 7.0 to 10, are then precipitated by adjustment of the pH of the extracts to, at or near the isoelectric point of the protein to form an insoluble curd precipitate. The actual pH to which the protein extracts are adjusted will vary depending upon the vegetable protein material employed but insofar as soy protein, this typically is between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The soy protein precipitates from the acidified extract, and is then separated from the extract. The separated protein may be washed with water to remove residual soluble carbohydrates and ash from the protein material and the residual acid can be neutralized to a pH of from about 4.0 to about 6.0 by the addition of a basic reagent such as sodium hydroxide or potassium hydroxide. At this point the protein material is subjected to a pasteurization step. The pasteurization step kills microorganisms that may be present. Pasteurization is carried out at a temperature of at least 180° F. for at least 10 seconds, at a temperature of at least 190° F. for at least 30 seconds or at a temperature of at least 195° F. for at least 60 seconds. The protein material is then dried using conventional drying means to form a soy protein isolate polymer.

Certain grades of soy protein polymers maintain a near native protein superstructure. Isolates prepared in the manner as above are unhydrolyzed isolates, that is, they are native soy proteins. The globular rigid structure has a relatively equal number of cationic and anionic sites that are very reactive. The combination of hydrophobic and charged regions helps maintain the globular protein subunits and makes them very self associating, resulting in high solution viscosities. The large number of cationic sites makes the unhydrolyzed proteins reactive to positively charged surfaces, such as to kaolin pigment, and are highly interactive with one another.

The soy polymers may also be modified. Preferably the protein material used in the present invention, is modified to enhance the characteristics of the protein material. The modifications are modifications which are known in the art to improve the utility or characteristics of a protein material and include, but are not limited to, denaturation and hydrolysis of the protein material.

The protein material may be denatured and hydrolyzed to lower the viscosity. Chemical denaturation and hydrolysis of protein materials is well known in the art and typically consists of treating an aqueous protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing a protein material are: a pH of up to about 10, preferably up to about 9.7; a temperature of about 50° C. to about 80° C. and a time period of about 15 minutes to about 3 hours, where the denaturation and hydrolysis of the aqueous protein material occurs more rapidly at higher pH and temperature conditions.

Hydrolysis of the protein polymer material may be effected by treating the protein material with an enzyme capable of hydrolyzing the protein. Many enzymes are known in the art which hydrolyze protein materials, including, but not limited to, fungal proteases, pectinases, lactases, and chymotrypsin. Enzyme hydrolysis is effected by adding a sufficient amount of enzyme to an aqueous dispersion of the protein material, typically from about 0.1% to about 10% enzyme by weight of the protein material, and treating the enzyme and protein material at a temperature, typically from about 5° C. to about 75° C., and a pH, typically from about 3 to about 9, at which the enzyme is active for a period of time sufficient to hydrolyze the protein material. After sufficient hydrolysis has occurred the enzyme is deactivated by heating to a temperature above 75° C., and the protein material is precipitated by adjusting the pH of the solution to about the isoelectric point of the protein material. Enzymes having utility for hydrolysis in the present invention include, but are not limited to, bromelain and alcalase.

Another form of modification is carboxylation of soy protein polymer by chemically modifying the soy protein polymer to give a protein having a higher anionic charge. By making the protein polymer more anionic there is an increase of the dispersant properties of the protein polymer and a reduction of the attraction to anionic dispersed-phase components. Since this protein polymer remains in the solution phase to a greater degree, it helps the distribution of components through their dispersant action. The result is greater adhesive strength, controlled structuring, higher water retention and lower viscosities than non-carboxylated soy products.

Soy protein polymers are commercially available from DuPont Soy Polymers, a division of The Solae Company, LLC, St. Louis, Mo. as DuPont™ Pro-Cote® soy polymers. A non-exhaustive list of these polymers are Pro-Cote® 200, Pro-Cote® 300, Pro-Cote® 427, Pro-Cote® 550, Pro-Cote® 2500, Pro-Cote® 2567, Pro-Cote® 4200, Pro-Cote® 4200S, Pro-Cote® 5000, Pro-Cote® 5000S and Pro-Cote® 6400.

The isolated soy protein, the base ingredient in Pro-Cote® polymers is a substance Generally Recognized As Safe for an intended use for paper and paperboard packaging when used in accordance with good manufacturing practices.

Casein animal protein polymer materials useful in the process of the present invention are prepared by coagulation of a curd from skim milk. The casein is coagulated by acid coagulation, natural souring, or rennet coagulation. To effect acid coagulation of casein, a suitable acid, preferably hydrochloric acid, is added to milk to lower the pH of the milk to around the isoelectric point of the casein, preferably to a pH of from 4.0 to 5.0, and most preferably to a pH of from 4.6 to 4.8. To effect coagulation by natural souring, milk is held in vats to ferment, causing lactic acid to form. The milk is fermented for a sufficient period of time to allow the formed lactic acid to coagulate a substantial portion of the casein in the milk. To effect coagulation of casein with rennet, sufficient rennet is added to the milk to precipitate a substantial portion of the casein in the milk. Acid coagulated, naturally soured, and rennet precipitated casein are all commercially available from numerous manufacturers or supply houses.

Corn protein polymer materials that are useful in the present invention include corn gluten meal, and most preferably, zein. Corn gluten meal is obtained from conventional corn refining processes, and is commercially available. Corn gluten meal contains about 50% to about 60% corn protein and about 40% to about 50% starch. Zein is a commercially available purified corn protein which is produced by extracting corn gluten meal with a dilute alcohol, preferably dilute isopropyl alcohol.

Wheat protein polymer materials that are useful in the present invention include wheat gluten. Wheat gluten is obtained from conventional wheat refining processes, and is commercially available.

A starch material may also be used in the present invention. Starch is a polymer of D-Glucose and is found as a storage carbohydrate in plants. The starch granules are completely insoluble in cold water but when heated the granules start to swell. The granules are useful to retain water after cooking.

The starch material used is preferably a naturally occurring starch. Starch materials useful in the process of the present invention include corn starch, wheat starch, rice starch potato starch, or pea starch. Preferably the starch material used is a corn starch or a wheat starch, and most preferably is a commercially available hydroxyethylated dent corn starch or native wheat starch. Preferred hydroxyethylated corn starches are commercially available from A. E. Staley Mfg., Co. and sold as Ethylex grades of starch, or from Penford Products Co. and sold as Penford Gum grades of starch.

Gums and resins also have utility within the present invention. Suitable gums for use in the present invention include cellulose gums such as methyl cellulose gums, carboxymethylcellulose gums, and hydroxyethyl cellulose gums. Suitable resins for use in the present invention include degradable water soluble resins such as water soluble polylactic acid polymers.

In a preferred embodiment, the degradable tie layer (C) of the process comprises a soy protein polymer. The process calls for applying the soy protein polymer or other polymer to the substrate layer (A) surface. In the process, the soy protein polymer that makes up the degradable tie layer (C) has both degradable and adhesive properties. The soy protein polymer used in the process promotes adhesion to the substrate layer (A) surface through the amphiphlic and amphoteric surface chemistry of the amino acids comprising the protein. The soy protein polymer also promotes adhesion among the polymers in the degradable tie layer (C), as well as to the substrate and resin surfaces.

The packaging structure composition of the process of this invention, and in particular the degradable tie layer (C), also encourages rapid degradation at the substrate-resin interface, thereby resulting in faster separation of the resin layer (B) from the substrate layer (A). Separation between the resin layer (B) and the substrate layer (A) creates more surface area, which will allow degradation of the packaging structure to be accomplished more readily.

In one embodiment, the degradable tie layer (C) is applied to the substrate layer (A) without pigment. In certain contexts, the presence of a pigment on the substrate is desirable. Accordingly, in another embodiment, the degradable tie layer (C) and pigment is applied to the substrate layer (A).

In a further embodiment, the degradable tie layer (C) can be used in combination with other materials, including pigments as noted above. Additionally, non-degradable binders may be employed with the degradable tie layer (C) so long as the ability to separate the resin/substrate bond through a microbial or simple recycling process step is maintained.

In one preferred embodiment, the soy protein will rapidly degrade in a moist environment through the action of bacterial or fungal enzymatic elements. In another preferred embodiment, the bond between the extruded resin and the soy protein polymer can be preferentially broken during recycling through an elevated pH condition, such as that achieved through the addition of an alkali such as sodium hydroxide.

In one embodiment, the process includes application of the degradable tie layer (C) to the substrate layer (A) prior to extrusion coating or lamination. A variety of application processes are available for this purpose. One such process is flexography, the method of printing most commonly used in packaging. In flexography, a print is achieved by creating a mirrored master of the required image as a three-dimensional relief in a rubber or polymer material. Ink, in a pre-determined amount, is deposited upon the surface of the printing plate using an anilox roll. The print surface then rotates, contacting the print material, which transfers the ink.

In another embodiment, application of the degradable tie layer (C) to the substrate layer (A) is accomplished through the use of the gravure process. In the gravure process an image is engraved onto an image carrier, in this instance a cylinder. The cylinder is particularly useful when application of the degradable tie layer is made on sheets of material.

In yet another embodiment, application of the degradable tie layer (C) to the substrate layer (A) is done through use of a roll coating process. This process is used for surface coating, color dying and printing on different media, including packaging material. The material to be coated is placed on a conveyor belt that directs the material through the rollers.

In still another embodiment, a rod coating process is used to apply the degradable tie layer. The rod coating process is used with web material; an excess of a coating material is applied to the web by an applicator roll. The web then passes over a wire wound rod whose size determines the final coat weight.

In each of the above described embodiments, the application of the degradable tie layer (C) to the substrate layer (A) may be done as a pretreatment during the fabrication of the substrate, as in a paper mill or converting operation or on the extrusion coating or lamination production line.

In another embodiment, the degradable tie layer may be applied to the surface of the substrate through a size process or calender water box. A size process is commonly used to apply a solution to dry paper, most often for strengthening effects.

Additionally, the degradable tie layer (C) also functions as an adhesive degradable tie layer to promote adhesion between the substrate layer (A) and the resin layer (B).

In a further embodiment, the degradable tie layer (C) may be applied to the substrate layer (A) during printing or on surface-coating equipment commonly installed on extrusion coating lines. Extrusion coating is a process used to apply a molten layer of an extrudate (the tie layer (C)) to the substrate layer (A). The substrate layer (A) must be of sufficient strength to withstand the temperature of the extrudate. Molten polymers are used in extrusion coating, since in the molten state such polymers are very viscous that flows onto the substrate. The flowing process allows the polymer to wet the entire surface evenly. When applied to porous substrates such as paperboard, molten polymers also enter the interstices of the uneven surface. Extrusion coating is therefore often used when adhesive properties are desired.

The amount of the resin layer (B) that resides on the degradable tie layer (C) is from about 0.2 to about 20 g/m²; preferably from about 0.5 to about 10 g/m² and most preferably from about 0.75 to about 3.0 g/m².

A requirement for this invention is that the tie layer (C) is a degradable tie layer. In order to determine degradability, the soy protein polymer is subjected to a Modified Sturm biodegradability test. This test covers the degree of aerobic aquatic biodegradation of a soy protein polymer on exposure of the soy protein polymer to a bacterial innoculum under laboratory conditions. A substance that is known to be biodegradable is tested simultaneously with the soy protein polymer. The reference substance is aniline The test measures the carbon dioxide evolved and therefor measures only “complete oxidation”.

A test material of a modified soy protein polymer identified as Pro-Cote® 6400 is introduced into a flask containing a mineral substrate and a bacterial innoculum. After ultrasonic vibration, the contents of the flask are aerated with carbon dioxide free air. Any carbon dioxide released is absorbed into flasks containing barium hydroxide slurry. Biodegradation is expressed as a percentage of the total amount of carbon dioxide evolved during the test. Typically, the test runs for 28 days. To obtain a “degradable rating”, at least a 60% or greater theoretical carbon dioxide production is necessary. As shown in the below table, the soy protein polymer yields a percent carbon dioxide of 88. This example demonstrates that a soy protein polymer is a biodegradable material.

TABLE 1

| | Soy Protein | Soy Protein | |
|---|---|---|---|
| Days | Isolate 10 mg | Isolate 20 mg | Control - Aniline 20 mg |
| 5 | 33.7% | 33.7% | 45.8% |
| 15 | 70.0 | 64.6 | 86.5 |
| 28 | 87.8 | 87.9 | 92.7 |

### EXAMPLE 2

In this example, the improvement in adhesion of the resin layer (B) to the substrate layer (A) is demonstrated when the degradable tie layer (C) is present. Sample 2a is a control sample that employs a pigmented substrate layer (A) and a resin layer (B). Sample 2b embodies the present invention and it employs the pigmented substrate layer (A), the resin layer (B) and the degradable tie layer (C). The substrate layer (A) of both samples is a poly coat food carton double coated SBS paperboard having a clay-calcium carbonate pigment. The resin layer (B) of both samples is a 3 mil thickness of a polyethylene. Also present in each sample are sodium alginate and polyvinyl acetate latex. The inventive sample contains a total of 27 grams per inch width (g/in) of Pro-Cote® 5000 soy polymer applied at a 12g/in width precoat and at a 15 g/in width topcoat. Control sample 2a and inventive sample 2b are evaluated in a coating adhesion test that measures the force to peel thermally-bonded polyethylene from a coated surface. The results are reported as coating adhesion in grams of force per inch of sample width. Control sample 2a has a 200 g/in coating adhesion and inventive sample 2b has a 410 g/in coating adhesion.

TABLE 2
Coating Adhesion

| Sample No. | Coating adhesion in g/in width |
|---|---|
| Industry minimum | 125 |
| 2a | 200 |
| 2b | 410 |

As shown in Table 2 the coating adhesion of control sample 2a is 200 g/in and that the coating adhesion of inventive sample 2b is 410 g/in. The use of the degradable tie layer (C) improves adhesion versus a sample wherein the degradable tie layer (C) is absent.

### EXAMPLE 3

In this example, the ability to degrade the adhesive bond between extrusion coated polymeric resins and cellulosic substrates of a sample of a packaging structure is demonstrated by the Wet X Cut test. The Wet X Cut test measures the percentage of substrate fiber tear resulting from peeling the resin film from the paperboard surface of the sample packaging structure after the packaging structure sample has been immersed in fluids for controlled duration. For the purpose of this experiment, degradation is simulated by 24 hours in alkaline water. These conditions are used to degrade the protein polymer tie layer (C) in the packaging structure in a manner that is similar to that in recycling, or through enzymatic degradation of the protein.

The Wet X Cut procedure is based on a modified method described in TAPPI T 539 cm-88 as maintained by the Technical Association of the Pulp and Paper Industry, Atlanta, Ga., with the addition for these experiments of sample immersion in water. This method is known to those skilled in the art as a simple technique for measuring resin film adhesion, and involves the following steps:

Cut a piece of a packaging structure sample to be tested that measures about 9 cm by 9 cm.

Fill containers with room temperature tap water at various pH points of 4.5, 8.7 and 10.0 or at any pH point in which the test is to be conducted. The pH is adjusted with either acetic acid or with aqueous sodium hydroxide.

Submerge the packaging structure sample one of the containers for a predetermined time of either 10 minutes or for 24 hours.

Remove the packaging structure sample from the container and lightly wipe excess water from the sample surface.

Cut an “X” through the extrusion coated resin layer (B) on the packaging structure sample, e.g., PET, LDPE or other polymers, by the use of a sharp razor blade. The cut is through the resin layer (B), but the cutting into the fiber of the substrate layer (A) is minimized. When cutting, the “X” is positioned relative to the machine or fiber direction of the board such that pulling the “X” apart will allow two tests in each machine direction and cross-machine direction.

Attach adhesive tape to the resin coating layer (B) on the packaging structure and pull the resin coating layer (B) away from the substrate layer (A) at the intersection of the “X” cut at a 180 degree angle. The use of adhesive tape minimizes damage to the fibers as the initial peel is started.

Observe the removed substrate layer (A) that is adhered to the resin layer (B). This rating is a percentage of substrate layer (A) that is adhered to the resin layer (B). The more substrate layer (A) that remains on the resin layer (B), that is, the less resin layer (B) that is exposed because the resin layer (B) is covered with the substrate layer (A), the higher the percentage rating. Fiber coverage of 100% means that the resin layer (B) is completely covered with fibers remaining adhered from the substrate layer (A). This indicates that the adhesion of the resin to the substrate, with or without a degradable tie layer (C), is very high and that degradation of the bond between resin and substrate has not been achieved. Conversely, fiber coverage of 0% means that no substrate layer (A) is adhered to the resin layer (B). This indicates that the adhesion of the degradable tie layer (C) is very low and that the degradation of the degradable tie layer (C) is very high.

In Table 3, two packaging samples identified as Sample 3a and Sample 3b are run in a side-by-side Wet X Cut test. The substrate layer (A) for Samples 3a and 3b is solid bleached sulfate paperboard. The resin layer (B) for Samples 3a and 3b is LDPE that is applied at about 8 grams per square meter and at a melt temperature during extrusion of 320° C. Sample 3a is a control sample that does not utilize a degradable tie layer (C) That is, the resin layer (B) is applied directly onto the substrate layer (A). Sample 3b is the inventive sample and the degradable tie layer (C) is applied at about 0.8 grams per square meter to the side of the paperboard to which the LDPE is extrusion coated.

The terms machine direction (MD) and cross direction (CD) are well-known in the art and refer to orthogonal directions in a sheet where physical properties are measured. The machine direction runs parallel with the windup direction of a paper machine. Cross direction refers to the direction perpendicular to the machine direction.

TABLE 3
Wet X-Cut Test

| | | | Sample 3a | | | Sample 3b | | |
|---|---|---|---|---|---|---|---|---|
| Test No. | Immersion Time | pH of water | MD | CD | Avg | MD | CD | Avg |
| 1 | No immersion | — | 100 | 100 | 100 | 100 | 100 | 100 |
| 2 | 10 Minutes | 4.5 | 100 | 100 | 100 | 100 | 100 | 100 |
| 3 | 10 Minutes | 8.7 | 100 | 100 | 100 | 70 | 50 | 60 |
| 4 | 24 Hours | 4.5 | 100 | 100 | 100 | 80 | 70 | 75 |
| 5 | 24 Hours | 8.7 | 80 | 90 | 80 | 50 | 20 | 35 |
| 6 | 24 Hours | 10.0 | 70 | 70 | 70 | 20 | 5 | 13 |

Test 1 is a baseline of a dry, non-immersed paperboard laminate. The results show that the resin/cellulosic laminate has excellent adhesion of the resin to the surface as it is made, and the degradable tie layer provides significantly more separation of the laminated structure after treatment. Within Sample 3b, adhesion as measured by the average of machine direction and cross machine direction values, is reduced 87% (from 100% when dry, to 13% when the soy protein tie layer is degraded by exposure for 24 hours to water at pH 10. Within Sample 3b, the adhesion is maintained at up to 75% of the original value by exposure to conditions not favorable to degradation of the tie layer (exposure for 24 hours in water at pH 4.5 in this example). Sample 3a, without the degradable tie layer (C), shows a drop in adhesion of only 30% (from 100% when dry, to 75% when subjected to the same treatment). This table demonstrates the ability to degrade a tie layer in an extrusion coated packaging laminate.

In another embodiment, the invention is directed to a process for making a packaging structure having degradable properties; comprising,

applying between

a substrate layer; and
a resin layer;
a degradable tie layer.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A packaging structure having degradable properties; comprising,
(A) a substrate layer;
(B) a resin layer; and
(C) a degradable tie layer;
wherein the degradable tie layer resides between the substrate layer and the resin layer.

2. The packaging structure of claim 1 wherein the substrate layer (A) is selected from the group consisting of paper and paperboard made from cellulose fibers.

3. The packaging structure of claim 1 wherein the substrate layer (A) comprises a synthetic fiber based web.

4. The packaging structure of claim 1 wherein the resin layer (B) is selected from the group consisting of an extruded resin and a film laminate.

5. The packaging structure of claim 1 wherein the resin layer (B) is a synthetic polymer selected from the group consisting of low density polyethylene, polyethylene terephthalate, a polyamide, a polylactic acid, paraffin waxes, polyvinylidene chloride, a compostable polyester and aluminum foil.

6. The packaging structure of claim 1 wherein the degradable tie layer (C) is selected from the group consisting of a polymer of vegetable and animal proteins, cellulosic ethers, starches, vegetable gums, amphoteric latexes, resins, and synthetic polymers and combinations thereof.

7. The packaging structure of claim 6 wherein the degradable tie layer (C) is a vegetable protein polymer selected from the group consisting of a soy protein polymer material, wheat gluten and zein.

8. The packaging structure of claim 7 wherein the soy protein polymer material is selected from the group consisting of a soy protein concentrate and a soy protein isolate.

9. The packaging structure of claim 1 further comprising a pigment layer residing between the substrate layer A and the degradable tie layer (C).

10. The packaging structure of claim 9 wherein the pigment is selected from the group consisting of calcium carbonate, calcined kaolin, hydrous kaolin, China clay, talc, mica, dolomite, silica, silicates, zeolite, gypsum, satin white, titania, titanium dioxide, calcium sulfate, barium sulfate, aluminum trihydrate, lithopone, blanc fixe, plastic pigment, and combinations thereof.

11. The packaging structure of claim 1 wherein the degradable tie layer (C) promotes adhesion between the substrate layer (A) and the resin layer (B).

12. A process for making a packaging structure having degradable properties; comprising, applying between
(A) a substrate layer; and
(B) a resin layer;
(C) a degradable tie layer.

13. The process of claim 12 wherein the substrate layer (A) is selected from the group consisting of paper and paperboard made from cellulose fibers.

14. The process of claim 12 wherein the substrate layer (A) comprises a synthetic fiber based web.

15. The process of claim 12 wherein the resin layer (B) is selected from the group consisting of an extruded resin and a film laminate.

16. The process of claim 12 wherein the resin layer (B) is a synthetic polymer selected from the group consisting of low density polyethylene, polyethylene terephthalate, a polyamide, a polylactic acid, paraffin waxes, polyvinylidene chloride, a compostable polyester and aluminum foil.

17. The process of claim 12 wherein the degradable tie layer (C) is selected from the group consisting of a polymer of vegetable and animal proteins, cellulosic ethers, starches, vegetable gums, amphoteric latexes, resins, synthetic polymers and combinations thereof.

18. The process of claim 17 wherein the degradable tie layer (C) is a vegetable protein polymer selected from the group consisting of a soy protein polymer material, wheat gluten and zein.

19. The process of claim 18 wherein the soy protein polymer material is selected from the group consisting of a soy protein concentrate and a soy protein isolate.

20. The process of claim 12 further comprising a pigment layer residing between the substrate layer A and the degradable tie layer (C).

21. The process of claim 20 wherein the pigment is selected from the group consisting of calcium carbonate, calcined kaolin, hydrous kaolin, China clay, talc, mica, dolomite, silica, silicates, zeolite, gypsum, satin white, titania, titanium dioxide, calcium sulfate, barium sulfate, aluminum trihydrate, lithopone, blanc fixe, plastic pigment, and combinations thereof.

22. The process of claim 12 wherein the degradable tie layer (C) promotes adhesion between the substrate layer (A) and the resin layer (B).
